(19) United States
(12) Patent Application Publication
(10) Pub. No.: US 2026/0228707 A1
(43) Pub. Date: Aug. 6, 2026

(54) ONLINE DATING SCHEDULING AND MATCHING PLATFORM

(71) Applicant: Dominic Bayless, Circle, CA (US)

(72) Inventor: Dominic Bayless, Circle, CA (US)

(21) Appl. No.: 19/636,547

(22) Filed: Apr. 1, 2026

Related U.S. Application Data
(63) Continuation-in-part of application No. 18/732,337, filed on Jun. 3, 2024, now abandoned.
(60) Provisional application No. 63/505,927, filed on Jun. 2, 2023.

(51) Int. Cl. G06Q 10/42; G06V 10/82; H04L 65/403; H04L 67/306; H04L 67/50

(52) U.S. Cl. CPC G06Q 10/42; G06V 10/82; H04L 65/403; H04L 67/306; H04L 67/535

(57) ABSTRACT

An online platform configured to facilitate the matching of users together on similar timelines based on their shared preferences for interests and locations, the platform being configured to prioritize matches in accordance with time (day, hours, minutes) at which they are available to chat and/or video conference. An automatic background generator enables users to depict their video call background to a place or topic to which both users share, helping to facilitate conversation during the date at the specific, agreed-upon time. The online dating platform is an artificial intelligence-enhanced dating application that integrates advanced behavior detection systems to identify and mitigate toxic or disruptive behavior during text and video interactions. The system employs AI to monitor and analyze user interactions, both textual and visual, flagging and reporting inappropriate behavior. The application tracks user reports, assigns unique user IDs for efficient monitoring, and implements content updates to enhance user experience.

### CONTINUITY

This application is a continuation application of non-provisional patent application number Ser. No. 18/732,337, filed on Jun. 3, 2024, and of provisional patent application number 63/505,927, filed on Jun. 2, 2023, and priority is claimed thereto.

### FIELD OF THE PRESENT INVENTION

The present invention relates to the field of online dating, and more specifically relates to a system and platform configured to facilitate the scheduling and matching of users to one another based off on interests and time available for an online video call to be enacted as an online date. The platform enables users to quickly and easily match with people who have shared interests, and place them in a virtual video chat room equipped with customized backgrounds that correspond to their shared location or topic of interest.

### BACKGROUND OF THE PRESENT INVENTION

Online dating has become a widely adopted practice for establishing personal and romantic connections. However, existing online dating platforms often present users with several challenges. The process of combing through profiles can be laborious and time-consuming, and users frequently encounter situations where they identify a potential match but cannot align schedules for a meaningful interaction. Additionally, most conventional platforms lack mechanisms to ensure commitment to scheduled interactions, often resulting in missed opportunities, frustration, and wasted time.

Unfortunately, most online dating platforms fail to accommodate scheduling into their criteria for matches and leave the actual scheduling of dates up to the users if/when they find each other. This can prove problematic for some users who find what appears to be the perfect match, only to find out later that they will never have a time at which both users are free to chat or video call. If there were a dating platform that put scheduling at the forefront, which enabled users to search for potential dates based on availability (time, date) in addition to shared interest and proximity filters, more users could have more effective dates and less time would be wasted by users seeking to find individuals who ultimately are not willing to put in a time at which they will make themselves available to meet up.

Further, these platforms often face challenges related to user behavior, including harassment, abuse, and inappropriate conduct. Addressing these issues is crucial to ensuring a safe and enjoyable experience for all users. Current solutions lack effective mechanisms for real-time detection and management of toxic behavior during both text and video interactions. If there were a way in which artificial intelligence could be employed to mitigate abusive and inappropriate behavior, users would benefit from a safer online dating experience.

Some similar solutions have been found in the prior art:

For example, Driscoll (US 2024/0257271 A1, published Aug. 1, 2024) discloses a social matching system configured to connect users based on shared characteristics and preferences. While Driscoll teaches improved matching techniques, the system fails to incorporate scheduling as a primary matching criterion and does not prioritize user availability as a foundational parameter for initiating interactions. In contrast, the present invention introduces a time-first matching architecture in which user availability is a primary filtering condition prior to profile-based selection.

Similarly, Benchetrit (US 2023/0118533 A1, published Apr. 20, 2023) describes a system for facilitating social or romantic connections using user profile data and algorithmic matching. However, Benchetrit does not provide a mechanism for structuring interactions around mutually committed time slots, nor does it enforce accountability for missed engagements. The present invention differs by enabling users to propose specific interaction times and by implementing enforcement mechanisms, such as penalties for repeated failure to attend scheduled dates.

Tunstall-Pedoe (US 2023/0259705 A1, published Aug. 17, 2023) discloses a system involving conversational or AI-assisted interaction environments. While Tunstall-Pedoe may incorporate intelligent interaction features, it does not address coordinated scheduling between users or provide a system in which temporal availability governs match formation. The present invention uniquely integrates scheduling constraints directly into the matching algorithm.

With respect to communication scheduling systems, Sachs (US 2020/0302825 A1, published Sept. 24, 2020) teaches methods for organizing and managing scheduled interactions. However, Sachs is not directed to dating platforms and does not integrate scheduling with compatibility matching based on shared interests or behavioral metrics. The present invention differs by combining scheduling with matchmaking and real-time interaction features within a unified dating platform.

Angapova (US 2020/0228941 A1, published Jul. 16, 2020) discloses systems relating to communication session management. While Angapova may address aspects of session control, it does not provide mechanisms for restricting access to sessions based on predefined temporal windows tied to user commitment, nor does it include enforcement policies for missed sessions. The present invention introduces controlled access windows and accountability mechanisms that enhance reliability of scheduled interactions.

France (U.S. Pat. No. 10,321,284 B1, issued Jun. 11, 2019) discloses communication systems with session-based features. However, France does not contemplate a dating-specific implementation wherein session access is dynamically controlled based on mutual user engagement signals or scheduling commitments. The present invention includes features such as early session access upon mutual participation and restricted re-entry conditions, which are absent in France.

With respect to artificial intelligence and moderation technologies, Baryshnikov (US 2024/0119184 A1, published Apr. 11, 2024) describes systems utilizing AI for content analysis. While Baryshnikov may teach automated content evaluation, it does not integrate real-time monitoring of live video dating interactions combining both natural language processing and computer vision within a unified moderation framework. The present invention uniquely applies multi-modal AI analysis during synchronous virtual dates.

Finder (US 2019/0065609 A1, published Feb. 28, 2019) discloses systems for detecting or analyzing user interactions, potentially including content moderation. However, Finder does not address real-time enforcement during scheduled interpersonal interactions nor does it integrate moderation with a dating-specific scheduling system. The present invention provides real-time behavioral monitoring during live dates and links such monitoring to user accountability mechanisms.

Hopkins (WO 2021/150771 A1, published Jul. 29, 2021) discloses systems related to monitoring or moderating user-generated content. While Hopkins may address safety concerns, it does not provide a system in which moderation is applied specifically within scheduled, synchronous dating sessions combined with scheduling enforcement and behavioral tracking across interactions.

Earlier references such as Robinson (US 2008/0070697 A1, published Mar. 20, 2008) and Hoal (US 2008/0282324 A1, published Nov. 13, 2008) generally disclose communication or networking systems. These references fail to address modern challenges associated with online dating platforms, including coordinated scheduling, real-time AI moderation, and dynamic user interaction environments. The present invention advances beyond these systems by integrating intelligent matching, scheduling, and safety features within a single platform.

Additional references such as Beaufrere (US 2014/0317732 A1, published Oct. 23, 2014) and VanBlon (US 2018/0143822 A1, published May 24, 2018) disclose systems related to user interaction and matching. However, these systems do not incorporate temporal availability as a primary matching parameter nor do they include mechanisms for analyzing user engagement duration as a compatibility metric. The present invention introduces a duration-based compatibility engine that matches users based on statistically similar interaction lengths, a feature absent from the cited art.

Finally, Krutsch (U.S. Pat. No. 10,819,758 B1, issued Oct. 27, 2020) discloses communication-related technologies but does not address the integration of scheduling, behavioral monitoring, and adaptive matchmaking within a dating context. The present invention provides a unified system that combines these elements to improve user experience and interaction success rates.

Thus, there remains a need for a comprehensive system that integrates scheduling, intelligent matching, behavioral accountability, and real-time safety monitoring within a unified online dating platform, as provided by the present invention.

Further, there is a need for a new online dating platform configured to match users based not only on shared interest and proximity, but on a day and time at which they would be willing to have a chat or video call, enacted as a virtual date in real-time. Such a platform preferably enables users to dictate to the platform a specific time and date at which they are willing to have a date (text chat and/or video chat). Likewise, the platform is equipped to also allow users to select dates from those that have proposed the specific time and date which aligns with their own availability. Further, such a platform and system preferably penalizes users who miss their scheduled dates more than three times, helping to provide accountability to the users, and minimize wasted time.

### SUMMARY OF THE INVENTION

The present invention is an online dating and video-dating platform configured to facilitate the matching of individuals based on common interests, common favorite places, and common times at which they may connect during a live video call. The platform is configured to enable users to propose a time for a date, referenced as a time-setter. Correspondingly, users, referenced as time-seekers, can browse available timelines of potential dates with which they have shared interest.

A dynamic background for video-dates is enacted by the platform of the present invention, enabling users to deliberately choose, or have the platform automatically select, pertinent background imagery to be shown to their date during their video call. If the platform selects the background imagery for the daters, information is pulled from shared interests between the two users, making the background relevant to helping to provide a topic of conversation for the date.

Artificial intelligence is employed to monitor behavior of users during dates and communications within the platform. Natural Language Processing (NLP) and computer vision are used to analyze interactions between users on dates. Further, users are provided the option to report inappropriate behavior during or after dates and/or interactions on the platform of the present invention.

Key features of the present invention preferably include:
AI-Powered Behavior Detection:
   The AI system monitors both text messages and video calls for signs of inappropriate behavior. It utilizes natural language processing (NLP) and computer vision techniques to analyze interactions. The AI detects verbal abuse, hate speech, and inappropriate visual content such as nudity or gestures.
User Reporting and Tracking:
   Users can report inappropriate behavior during or after interactions. Each user is assigned a unique ID for efficient tracking of reports and behavioral patterns. The system logs all reports and uses AI to aggregate and analyze data, identifying repeat offenders.
Automated Response and Moderation:
   The AI assigns severity levels to incidents based on predefined keywords and behavior patterns. For severe or repeated offenses, the system can automatically suspend or ban users. Moderators receive detailed reports generated by the AI for review and final decision-making.
Content Updates and User Experience Enhancements:
   Monthly updates introduce new backgrounds, interactive elements, and features to enhance video call experiences. The application ensures a fresh and engaging environment, encouraging positive interactions.

The following brief and detailed descriptions of the drawings are provided to explain possible embodiments of the present invention but are not provided to limit the scope of the present invention as expressed herein this summary section.

### BRIEF DESCRIPTION OF DRAWINGS OF THE PRESENT INVENTION

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 shows a screenshot of an embodiment of the platform of the present invention, depicting a scheduler screen.

FIG. 2 exhibits a flow chart detailing the process of use of the platform and system of the present invention by a user.

FIG. 3 depicts an example of a Time-seeker screen as the user reviews potential dates which have been proposed by time-setter users.

FIG. 4 depicts an example of a Time-setter screen as the user sets up a date to be proposed, including setting the time of the date, the duration of the date, and the background/setting for the date.

FIG. 5 shows an example of the date screen of the present invention, depicting two users on a live date as scheduled and matched on the system and platform of the present invention.

FIG. 6 shows an example of a python script detailing the text analysis module of the present invention.

FIG. 7 shows an example of a python script detailing the video analysis module of the present invention.

FIG. 8 shows an example of a python script detailing the reporting feature of the present invention.

FIG. 9 shows an example of a python script detailing the AI-driven moderation (severity score assignment) of the present invention.

FIG. 10 shows a flow chart detailing a process flow for generating compatibility outputs within the system of the present invention.

FIG. 11 shows an example screenshot of the “Time Setter” selection screen.

FIG. 12 shows an example screenshot of the “Time Seeker” selection screen.

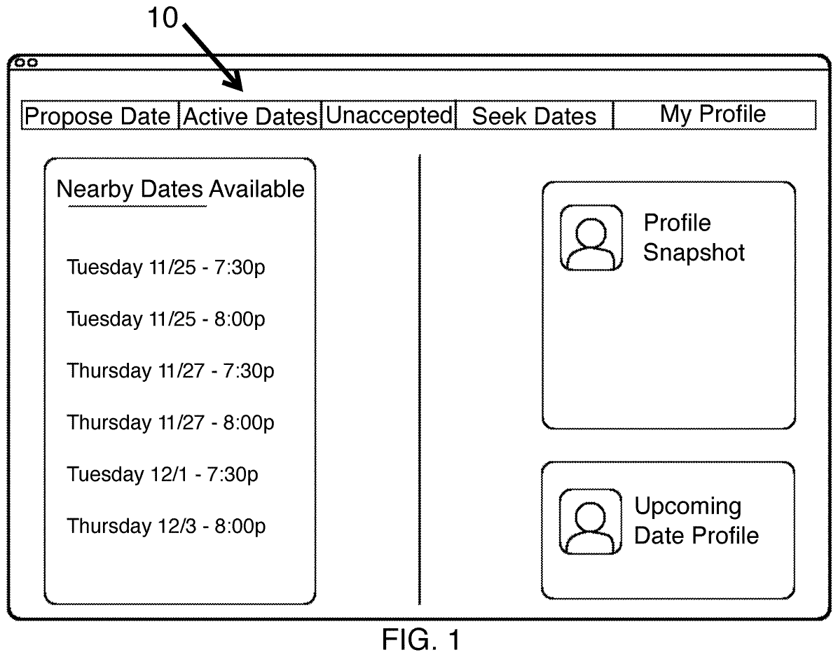

### DETAILED DESCRIPTION OF THE PRESENT INVENTION

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to affect such feature, structure, or characteristic in connection with other embodiments whether or not explicitly described.

### The Present Invention

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The present invention is an online platform (10) and system configured to facilitate the matching of individuals for one or more online dates. Matches are enacted based on shared availability (including time of day and day of the week), shared interests, and proximity to one another.

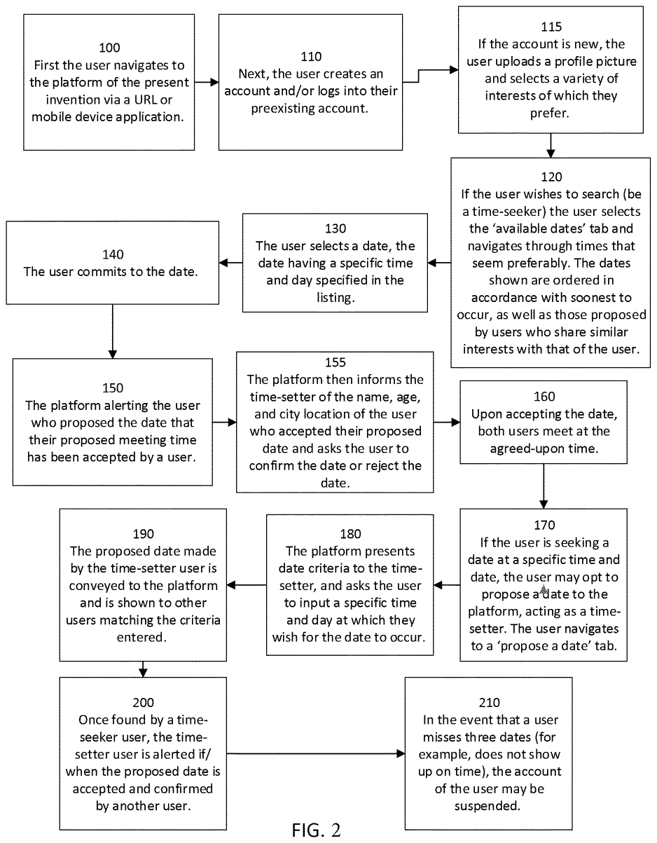

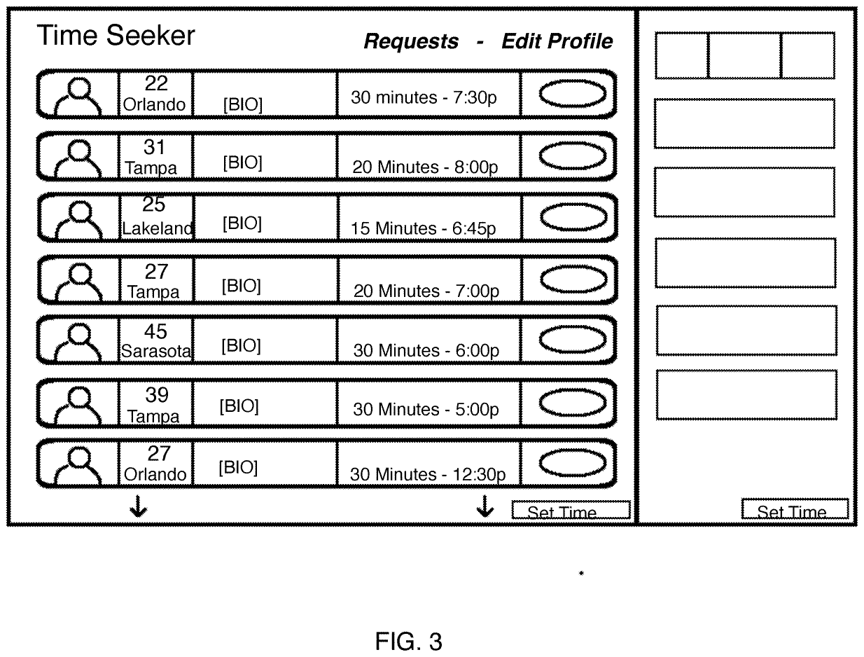

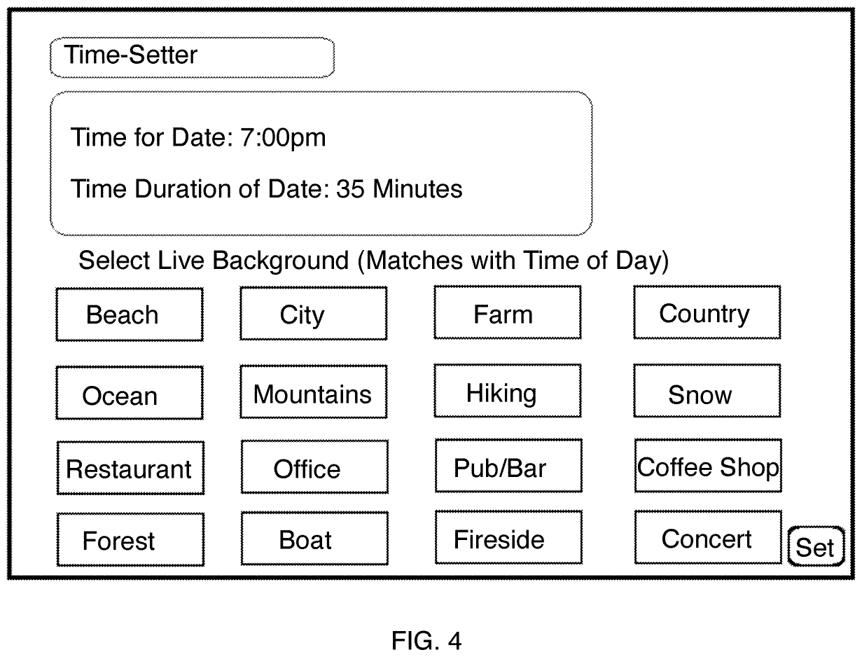

As outlined in FIG. 2, the process of use of the platform and system of the present invention by a user is preferably as follows:
1. First the user navigates to the platform of the present invention via a URL or mobile device application. (100)
2. Next, the user creates an account and/or logs into their preexisting account. (110)
3. If the account is new, the user uploads a profile picture and selects a variety of interests of which they prefer. (115)
4. If the user wishes to search (be a time-seeker) the user selects the ‘available dates’ tab and navigates through times that seem preferably. The dates shown are ordered in accordance with soonest to occur, as well as those proposed by users who share similar interests with that of the user. (120)
5. The user selects a date, the date having a specific time and day specified in the listing. (130)
6. The user commits to the date. (140)
7. The platform alerting the user who proposed the date that their proposed meeting time has been accepted by a user. (150)
8. The platform then informs the time-setter of the name, age, and city location of the user who accepted their proposed date and asks the user to confirm the date or reject the date. (155)
9. Upon accepting the date, both users meet at the agreed-upon time. (160) Meetings can occur via text, or preferably via a video conference. The video conference software is preferably embedded within the platform of the present invention, or may be conducted externally such as through a service or application such as Zoom TM, Google TM Meet, or similar service. If embedded via API, the video conference software may optionally propose pertinent backgrounds to the user(s) based on their shared interests (such as a location) to foster communication during the date.
10. If the user is seeking a date at a specific time and date, the user may opt to propose a date to the platform, acting as a time-setter. The user navigates to a ‘propose a date’ tab. (170)
11. The platform presents date criteria to the time-setter, and asks the user to input a specific time and day at which they wish for the date to occur. (180) The user may also input additional criteria as to who may accept the date in some embodiments of the present invention.
12. The proposed date made by the time-setter user is conveyed to the platform and is shown to other users matching the criteria entered. (190)
13. Once found by a time-seeker user, the time-setter user is alerted if/when the proposed date is accepted and confirmed by another user. (200)
14. In the event that a user misses three dates (for example, does not show up on time), the account of the user may be suspended. (210)

It should be noted that, within minutes or even hours, a user is preferably able to change from being a time-seeker to a time-setter (or vice versa) if a date in unable to be found. The platform (10) is preferably configured to warn the user two hours beforehand if a person has yet to commit to the user's proposed date/time. At that time, the user may opt to cancel or change time or seek for more times for which they are available. This allows for flexibility for people to find dates thoroughly and with as little trouble as possible.

In one embodiment, a computer-implemented dating system provides a scheduled virtual date session between two matched users. Upon confirmation of the date, the system enables either user to access the date session interface prior to a scheduled start time. When only one user accesses the session prior to the scheduled start time, the system displays a placeholder or inactive visual state corresponding to the absent user. When both users access the session prior to the scheduled start time, the system enables full interactive functionality, thereby permitting early participation by mutual consent communicated through an external or internal messaging channel.

The system further restricts access to the date session upon expiration or termination of the scheduled date period. Once the date session has ended, re-entry to the session is prevented unless an additional access condition is satisfied, including but not limited to payment, credit usage, or premium authorization. This access control mechanism introduces temporal flexibility while preserving system-defined boundaries for session reuse.

In certain embodiments, the system introduces a time-bound virtual meeting protocol designed to prevent user no-shows and increase interpersonal accountability. Upon scheduling a date, the platform designates a fixed appointment time (e.g., 7:00 PM) and subsequently generates a restricted access interval surrounding the appointment. In one example, users may only enter the virtual meeting environment during a predetermined window beginning no earlier than fifteen minutes prior to the appointment time and ending no later than thirty minutes after the appointment time (e.g., 6:45 PM to 7:30 PM for a 7:00 PM appointment).

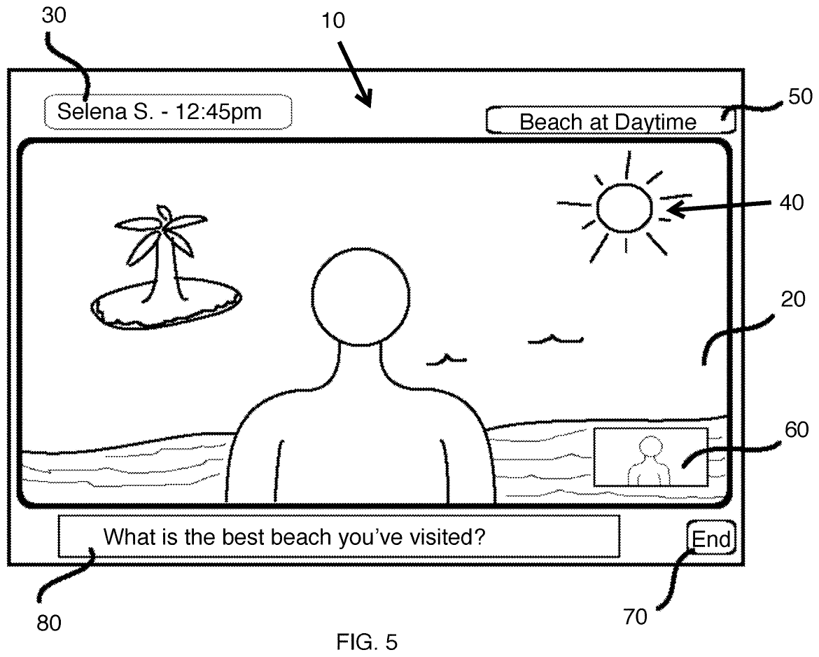

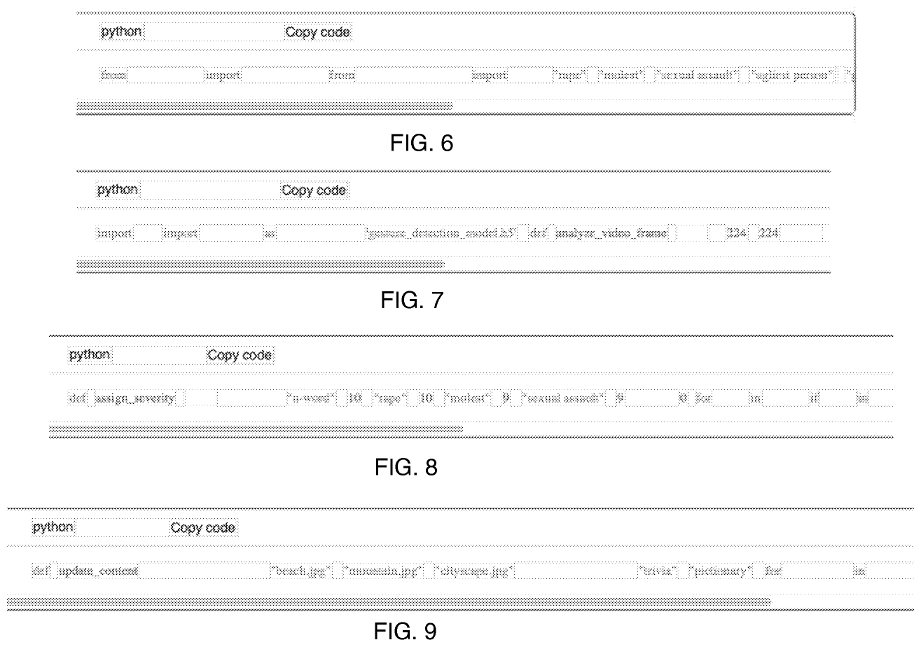

As depicted in FIG. 5, dates conducted between a time-setter user and a time-seeker user appear on a video date screen (20). On the video date screen (20), date information is presented in a date information section (30) which reminds each user of the name of their match, as well as the time of the arranged date. A selected, time-sensitive background (40) is shown behind each user, and the name of the background is shown in a background information box (50). The matched user is shown in the large display, and a thumbnail display (60) shows the user a live feed of themselves. An End Date button (70) is preferably present to facilitate early termination of a date if desired. A prompt or question is preferably shown to one or both users of the date within a prompt box (80) on the video date screen (20). The prompt or question is geared to stimulate conversation between the pair during the date. The prompt or question may or may not be related to the background depicted.

Additionally, it should be noted that preferred embodiments of the present invention are equipped with elements which employ machine learning (Artificial Intelligence, A.I.) to enhance and expedite the matching experience for users. For example, when a user views a list of times set by time-setter users, the AI of the system and platform of the present invention is able to order the users who set and confirm dates quickly at the top of the list. Therefore, if a time-setter user sets a time for a date at 7:00 PM, and confirms a match 15 minutes later, that user will be placed at the top of the list for other users who also confirm dates within the first 30 minutes of proposing a date time.

In one embodiment, the system comprises a Virtual Date Duration Tracking Module configured to record, store, and analyze the temporal length of each completed virtual video date session between two registered users. Each session duration is logged in milliseconds within a secure time-stamped record on the application's cloud-based database. The module utilizes a statistical analysis subroutine to determine the mean session duration per user across their last N completed virtual dates, where N is dynamically adjustable based on user activity level (default value=5). The module further includes an algorithmic comparator engine configured to identify users whose average session durations fall within a ±15% variance threshold of one another. These users are classified under a comparable attention span index and algorithmically prioritized in each other's recommendation queues. The prioritization weighting is executed via an adaptive ranking model that increases match visibility score (MVS) proportionally to the degree of similarity in session duration metrics.

The platform and system of the present invention exhibits comprehensive system architecture comprising a frontend user interface and a backend artificial intelligence engine. The dating application consists of a frontend user interface designed for user interaction, referenced as the platform, while the backend AI engine processes data and handles behavior detection. The backend AI engine is divided into three main modules: Text Analysis, Video Analysis, and Report Management.

The behavior detection mechanism includes a Text Analysis Module that uses Natural Language Processing (NLP) algorithms to scan messages for harmful language. The module includes a database of predefined keywords and phrases indicating abusive or inappropriate behavior, such as “rape,” “molest,” “sexual assault,” “You're the ugliest person I've ever seen,” and “I am going to find you and . . . ” NLP techniques such as sentiment analysis and keyword matching are employed to detect toxic language. When a keyword or phrase is detected, the system flags the message for further review.

The Video Analysis Module uses computer vision techniques to analyze live video streams. It employs object detection and gesture recognition algorithms to identify inappropriate visual content. The system can detect nudity, obscene gestures, and other forms of visual harassment. When inappropriate content is detected, the system flags the video interaction for review.

The User Report Management system enables users to report inappropriate behavior directly through the application's interface by selecting a “Report” button. The report form allows users to specify the type of inappropriate behavior (e.g., verbal abuse, visual harassment) and provide additional details. Each user is assigned a unique ID upon registration, which is used to track all interactions and reports associated with that user. The system logs each report in a database, associating it with the user's unique ID for comprehensive tracking.

The AI-Driven Moderation system assigns severity scores to reported incidents based on predefined criteria and patterns. The criteria include the frequency of reports, severity of language or actions, and context of the interaction. For example, use of the n-word or threats of violence are assigned higher severity scores. The AI system can take automated actions such as issuing warnings, suspending accounts temporarily, or permanently banning users based on these scores. Detailed incident reports are generated for human moderators to review borderline cases and make final decisions.

In a further embodiment, the system automatically unlocks early access to the date session upon detection of a first message exchanged between the matched users following date confirmation. The transmission of said first message serves as an implicit signal of mutual intent, thereby enabling early session access without requiring adherence to the originally scheduled start timestamp.

The system includes a time-setting module configured to allow a first user (“the setter”) to schedule a designated interaction time (“set time”) with a second user within the application interface. Once a set time is confirmed, the system automatically restricts the user's ability to initiate or accept additional “seek” requests within a pre-defined temporal buffer window extending both before and after the scheduled time.

In one embodiment, the buffer window is fifteen (15) minutes prior to and fifteen (15) minutes following the scheduled set time. For example, if a user has scheduled a meeting at 7:00 PM, the system will disable the option to create or accept new time-based interactions between 6:45 PM and 7:20 PM. This restriction ensures exclusive user engagement for the scheduled interaction and prevents scheduling conflicts or overlapping connection attempts.

The system further includes a virtual communication interface that provides an integrated chat continuity function during live video sessions. Upon initiating a virtual call between users, the application automatically links the ongoing video session to the same chat log previously used by both parties for text communication.

In the event of audio transmission issues, such as a malfunctioning microphone, users may access the linked chat interface concurrently with the video call to maintain communication without disruption. This feature enhances accessibility and user experience by enabling seamless transition between text and video communication modes within a unified chat environment.

It should be understood that the present invention is an AI-enhanced dating application and platform that provides a robust solution for managing toxic behavior, ensuring a safer and more enjoyable user experience. By leveraging advanced AI technologies, the system effectively detects, reports, and mitigates inappropriate conduct, fostering a respectful and engaging environment for online dating. The system and platform also facilitate prudent matching based on time-of-day availability based on user preferences, making it more likely to find a match suitable to ones interests and personality, as well as a match suitable to meeting at a time-of-day at which both parties are available.

Other embodiments may offer additional differing features. For example, in one embodiment, the system comprises a Background Pattern Recognition Module configured to analyze and classify the visual environment of a user during a virtual date session. The module employs a neural-network-based vision engine utilizing convolutional pattern recognition techniques to process video frames captured during live sessions. The system extracts dominant visual features including, but not limited to, color histograms, object detection data, edge structures, and spatial composition.

The extracted features are processed to assign an environmental classification label to the user's surroundings, such as “residential interior,” “café,” “office,” “outdoor park,” or “beach.” The classification is stored as metadata associated with the user profile for each session.

When a user conducts a plurality of virtual date sessions, the system evaluates environmental consistency across prior sessions. If a user is determined to have conducted at least three (3) of their previous five (5) sessions within the same classified environment, the system establishes a persistent behavioral parameter defined as a Comfort Environment Parameter (CEP). The CEP is stored within the user profile and utilized as a compatibility factor during matchmaking.

The system further compares CEP values across users and prioritizes matches between users exhibiting a predefined similarity threshold, such as at least sixty percent (60%) correspondence in environmental classification. In the event of a detected environmental deviation across consecutive sessions, the system initiates a recalibration protocol configured to temporarily suspend prior CEP weighting until a new pattern is established.

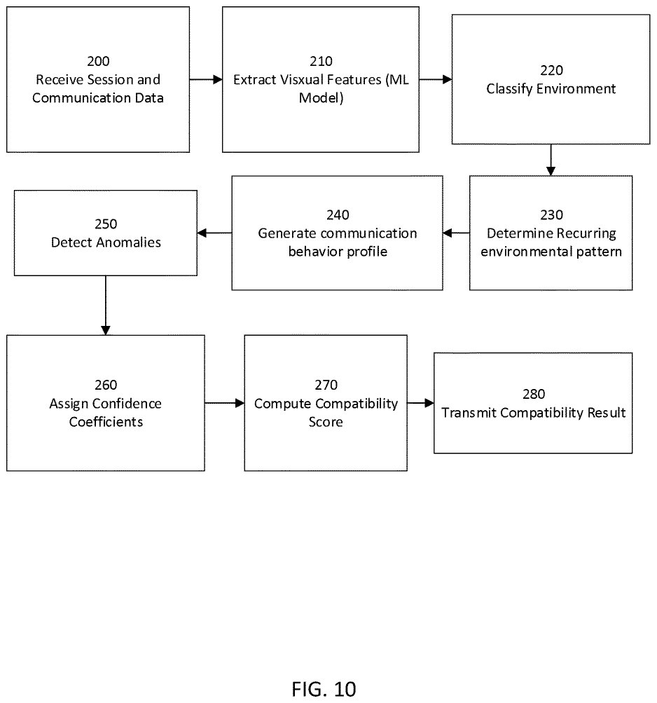

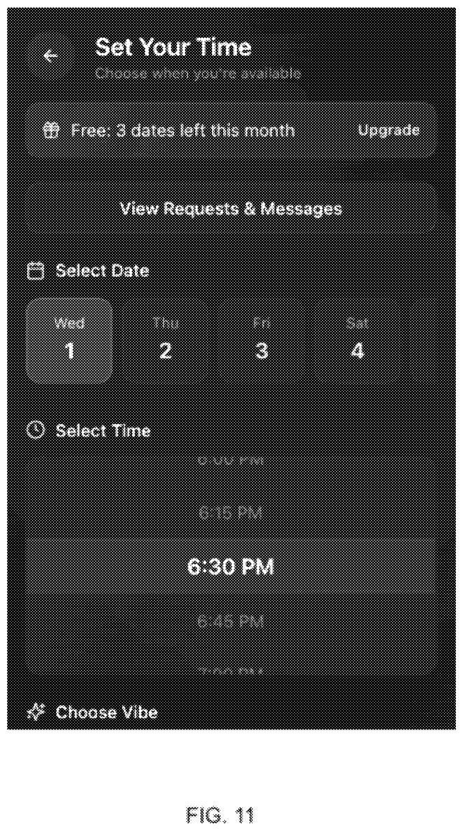

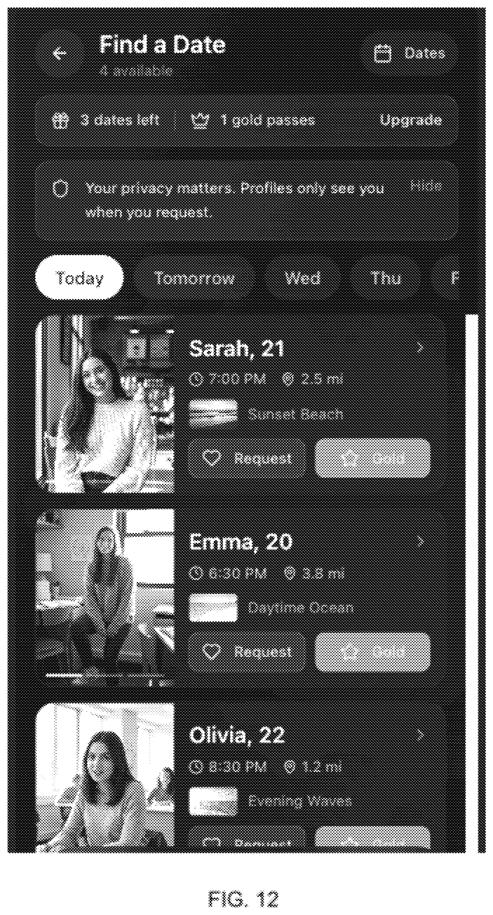

FIG. 10 illustrates an exemplary process flow for generating compatibility outputs within the system. The process begins when the system receives session data and communication data (200) associated with one or more users, including information derived from prior virtual interactions. The system then applies a machine learning model to extract visual features (210) from video session data, which are used to classify the user's environment into one or more predefined categories. Based on a plurality of prior sessions, the system determines whether a recurring environmental pattern exists for each user, thereby establishing a behavioral consistency metric (230). In parallel, the system analyzes communication data to generate a communication behavior profile (240), taking into account factors such as message frequency and response timing. The system further evaluates the collected data to detect anomalies (250) by comparing current data points against historical behavioral baselines, and assigns confidence coefficients (260) to the data based on the degree of deviation. Using the environmental pattern, communication profile, and confidence-weighted data, the system computes a compatibility score (270) between users. Finally, the system transmits a compatibility result (280) to one or more user devices, thereby enabling improved matching and interaction outcomes.

In one embodiment, the system includes a Texting Duration and Frequency Analysis Module configured to evaluate user communication behavior occurring prior to the initiation of a virtual date session. The module collects and processes timestamped message data exchanged between users, including total message count, duration of communication periods, and response latency intervals.

The system generates a communication profile vector for each user, comprising quantitative and temporal communication attributes. These attributes are processed using a clustering algorithm configured to identify users with communication patterns falling within a defined similarity threshold, such as within twenty percent (20%) variance.

Users classified within a similar communication cluster are assigned to a compatible communication-type cluster (CCTC), which is incorporated into the matchmaking algorithm as a weighting factor. The system may further include an outlier detection mechanism configured to identify extreme communication behaviors falling within a predefined percentile range. Such outliers are normalized using corrective weighting factors to prevent distortion of compatibility calculations.

Additionally, the module may incorporate a feedback-based learning mechanism configured to update correlation values between communication patterns and successful user engagement outcomes based on post-session feedback data.

In one embodiment, the system comprises an Inactivity Auto-Engagement Protocol configured to detect and re-engage inactive users. A user is designated as inactive upon failing to initiate or respond to interactions within a predefined time interval, such as fourteen (14) consecutive days.

Upon detection of inactivity, the system automatically retrieves a previously identified compatible user based on a Behavioral Compatibility Index (BCI) derived from prior matching algorithms. The system initiates a temporary, system-generated communication instance between the inactive user and the selected compatible user.

The communication instance includes a system-generated prompt inviting one or both users to schedule a virtual date. If no interaction occurs within a predefined period, such as forty-eight (48) hours, the system automatically terminates the communication instance and resets the inactivity monitoring cycle. If engagement occurs, the system resumes standard activity tracking and updates the user's behavioral metrics accordingly.

In one embodiment, the system includes an Anomaly Detection and Data Integrity Module configured to maintain reliability of user behavioral data across all analytical subsystems. The module continuously evaluates incoming data streams from system components including, but not limited to, session duration tracking, communication analysis, and engagement monitoring. Each behavioral datapoint is assigned a confidence coefficient (CC), initially set to a baseline value representing full confidence. The system evaluates each datapoint against user-specific behavioral baselines and identifies anomalies defined as deviations exceeding a predetermined statistical threshold, such as two (2) standard deviations.

Upon detection of an anomalous datapoint, the system reduces the associated confidence coefficient and flags the datapoint for provisional status. If subsequent datapoints corroborate the deviation, the system restores the confidence coefficient. Conversely, persistent anomalies may result in further reduction of the coefficient or escalation to a data verification process. This module ensures adaptive responsiveness to evolving user behavior while preserving statistical integrity of the dataset utilized for matchmaking and behavioral analysis.

In one embodiment, the system comprises a Seasonal Thematic Update System configured to dynamically modify user interface elements and virtual environments based on predefined temporal events. The system accesses a centralized content repository containing themed visual assets corresponding to calendar-based events such as holidays or seasonal periods.

During designated time intervals, the system deploys themed overlays, backgrounds, and interactive elements across the platform interface. The system synchronizes the thematic presentation across users to provide a shared interactive experience during virtual date sessions. The module further tracks engagement metrics including session duration, user return frequency, and interaction rates associated with thematic content. Upon expiration of the designated interval, the system automatically reverts to a default interface configuration while retaining performance data for future optimization.

In one embodiment, the system includes a session validation mechanism configured to identify and manage short-duration virtual date sessions. Sessions having a duration below a predefined threshold, such as ten (10) minutes, are flagged as low-engagement anomalies. The system temporarily excludes such sessions from statistical analysis used in compatibility determination unless validation criteria are satisfied. Validation criteria may include subsequent sessions of standard duration within a predefined time window or explicit user confirmation indicating that the short session was intentional. This mechanism ensures that anomalous session data does not disproportionately influence user compatibility metrics.

In one embodiment, the system provides a Paid Reconnection Feature configured to facilitate post-session communication following an interrupted or prematurely terminated virtual date session. Upon detection of an unexpected session termination event, the system presents the initiating user with an option to transmit a one-time follow-up communication upon completion of a transactional condition, such as payment of a predefined fee or expenditure of platform credits.

The follow-up communication enables the initiating user to provide contextual information regarding the interruption or to request continuation of communication through exchange of contact information. The recipient user retains full discretion to accept or ignore the communication, thereby preserving user autonomy and privacy.

The system records the reconnection attempt and integrates the interaction outcome into user engagement metrics. This feature enhances user experience by mitigating the impact of technical disruptions while providing a controlled mechanism for continued interaction.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A computer-implemented system for generating compatibility outputs between users in a virtual interaction platform, comprising:
at least one processor;
a memory storing instructions executable by the at least one processor; and
a plurality of software modules configured to:
receive and store user interaction data comprising communication data, session data, and environmental data captured during virtual sessions;
process the environmental data using a trained visual recognition model to extract feature vectors and assign an environmental classification label;
determine a behavioral consistency metric based on repetition of the environmental classification label across a plurality of sessions;
generate a communication profile vector based on message frequency, response latency, and communication duration;
calculate a compatibility score between a first user and a second user using at least the behavioral consistency metric and the communication profile vector; and
output a compatibility indication based on the compatibility score,
wherein the system dynamically adjusts weighting of at least one input parameter based on detected anomalies in the user interaction data.

2. The system of claim 1, wherein the trained visual recognition model comprises a convolutional neural network configured to analyze pixel-level image data.

3. The system of claim 1, wherein the environmental classification label includes at least one of:
residential interior, commercial location, outdoor environment, or workspace.

4. The system of claim 1, wherein the behavioral consistency metric is generated when at least three out of five prior sessions share a common environmental classification.

5. The system of claim 1, wherein the communication profile vector further includes a response latency variance metric.

6. The system of claim 1, wherein the compatibility score is generated using a weighted scoring algorithm that adjusts based on historical engagement outcomes.

7. The system of claim 1, further comprising an inactivity detection module configured to identify users inactive for a predetermined period and initiate an automated engagement event.

8. The system of claim 7, wherein the automated engagement event includes generating a system-initiated communication between previously matched users.

9. The system of claim 1, wherein the anomaly detection comprises identifying deviations exceeding a statistical threshold of at least two standard deviations.

10. The system of claim 1, wherein the confidence coefficient is reduced in response to detected anomalous data.

11. The system of claim 1, wherein the system is configured to exclude session data below a predefined duration threshold from compatibility calculations.

12. The system of claim 11, wherein the predefined duration threshold is less than ten minutes.

13. The system of claim 1, further comprising a thematic interface module configured to dynamically modify user interface elements based on temporal conditions.

14. The system of claim 1, further comprising a reconnection module configured to enable a user to transmit a post-session communication following an interrupted session.

15. A computer-implemented method for improving compatibility determination in a virtual interaction system, comprising:
receiving, by a processor, session data and communication data associated with a plurality of users;
extracting, using a machine learning model, visual features from session video data and classifying an environment associated with each session;
determining, for each user, a recurring environmental pattern based on a threshold number of prior sessions;
generating a communication behavior profile based on at least message timing and frequency metrics;
identifying anomalous data points by comparing the session data and communication data against a statistical baseline;
assigning a confidence coefficient to each data point based on the identifying step;
computing a compatibility score between users using weighted inputs including the recurring environmental pattern, the communication behavior profile, and the confidence coefficient; and
transmitting a compatibility result to at least one user device.

16. The method of claim 15, further comprising clustering users into communication-type groups based on similarity of communication behavior profiles.

17. The method of claim 15, further comprising recalibrating the recurring environmental pattern upon detecting a change in user environment across consecutive sessions.

18. The method of claim 15, further comprising excluding anomalous data from compatibility calculations unless corroborated by subsequent data points.

19. The method of claim 15, further comprising:
generating a user engagement metric based on post-session interaction data and updating weighting parameters accordingly; and
initiating a system-generated interaction when a user satisfies an inactivity condition defined by a threshold time interval.

20. A method for facilitating dating matches between users online on a platform configured to mitigate inappropriate behavior, the method comprising:
a server computer hosting a platform to a domain;
users accessing the platform via the internet on a mobile device equipped with a camera and a microphone;
the server computer suggesting matches to users for dates according to an algorithm informed by an analysis of users'interests and time available for an online date;
wherein parameters of the algorithm include gender, age, religion, ethnicity, location, and time available for a date;
a first user matching with a second user;
the second user agreeing to meet via an online date on the platform at a time posited by the first user;
the first user meeting the second user during a video call;
AI of the platform monitoring the video in real-time and analyzing speech, mannerisms, posture, and gestures of both the first user and the second user to detect signs of inappropriate behavior;
AI flagging either the first user or the second user if inappropriate behavior is detected;
wherein the AI employs natural language processing and computer vision techniques to analyze user interactions during video calls; and
wherein inappropriate behavior includes, but is not limited to: typing or saying aloud predefined keywords indicating abuse and abusive posture as detected via AI visual analysis.
